(19) United States
(12) Patent Application Publication
(10) Pub. No.: US 2005/0094968 A1
(43) Pub. Date: May 5, 2005

(54) Data processing system and method

(75) Inventors: Stuart A. Green, Sheffield (GB); Richard Allan Knight, Sheffield (GB)

Correspondence Address: WILMER CUTLER PICKERING HALE AND DORR LLP, 60 STATE STREET, BOSTON, MA, 02109, US

(73) Assignee: Zoo Digital Group Plc

(21) Appl. No.: 10/756,976

(22) Filed: Jan. 14, 2004

(30) Foreign Application Priority Data
Nov. 4, 2003 (GB) GB 0325713.6

(51) Int. Cl. G11B 27/00

(52) U.S. Cl. 386/52; 715/723

(57) ABSTRACT

An authoring method for creating an audiovisual product. The method has three main stages. The first stage defines components implicitly representing functional sections of audiovisual content and transitions that represent movements between components. The second stage expands the components and transitions to provide a set of explicitly realised AV assets and an expanded intermediate data structure of nodes and links. Each node is associated with one of the AV assets and the links represent movement from one node to another. The third stage creates the audiovisual product in a predetermined output format, using the AV assets and the expanded intermediate data structure of the nodes and the links, wherein the audiovisual product comprises data representing merged first and second video data.

### FIELD OF THE INVENTION

The present invention relates in general to a data processing method and system.

### BACKGROUND TO THE INVENTION

In general terms, it is desired to assemble many small sections of raw audio and video content (i.e. sound clips and video clips) to form a finished audiovisual product, by way of an authoring process. However, in many environments a considerable degree of specialist knowledge and time must be invested in the authoring process in order to achieve a desirable finished audiovisual product. These problems are exacerbated where the audiovisual product has a complex navigational structure or requires many separate raw content objects.

As a simple example, a feature movie or television program typically has a straightforward linear navigational sequence of individual scenes. By contrast, it is now desired to develop new categories of audiovisual products which have a much more complex navigational structure, such as a movie with many scene choices or different movie endings, and/or which have a large number of individual scenes, such as an interactive quiz game with say one thousand individual quiz questions.

An optical disc is a convenient storage media for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-video, DVD-audio, and DVD RAM, amongst others. Of these, DVD-video is particularly intended for use with pre-recorded video content, such as a motion picture. As a result of the large storage capacity and ease of use, DVD discs are becoming popular and commercially important. Conveniently, a DVD-video disc is played using a dedicated playback device with relatively simple user controls, and DVD players for playing DVD-video discs are becoming relatively widespread. More detailed background information concerning the DVD-video specification is available from DVD Forum at www.dvdforum.org.

Although DVD-video discs and DVD-video players are becoming popular and widespread, at present only a limited range of content has been developed. In particular, a problem arises in that, although the DVD specification is very flexible, it is also very complex. The process of authoring content into a DVD-video compatible format is relatively expensive and time consuming. In practice, the flexibility and functions allowed in the DVD-video specification are compromised by the expensive and time consuming authoring task. Consequently, current DVD-video discs are relatively simple in their navigational complexity. Such simplicity can impede a user's enjoyment of a DVD-video disc, and also inhibits the development of new categories of DVD-video products.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-video product must be explicitly defined by the author. Hence, creating a DVD-video product with a complex navigational structure is expensive, time-consuming and error-prone.

Current DVD-Video authoring tools use some form of user interface to define a project for producing a DVD-Video disc image, that is, for producing the data structures and navigation information for such a DVD-Video disc. Ultimately such authoring tools eventually multiplex the video, audio and sub-picture parts, that is, the DVD assets, in accordance with the DVD-Video specification and format the resulting files together with the associated navigation information to yield a DVD-Video disc image.

A significant limitation of prior art DVD authoring systems is that the authors must, or usually, use the same authoring tools for any given project. It will be appreciated that the situation is exacerbated if one contemplates creating a DVD or marshalling the assets to create a DVD-Video disc image using different authoring tools. Many authoring companies or facilities will use their preferred authoring tools. For example, a popular authoring tool is Scenarist available from Sonic Solutions. However, there are some aspects of the DVD specification such as, for example, seamless branching, that the Scenarist authoring tool does not support. Therefore, if an authoring company or facility is asked to undertake a project for which seamless branching is required, they will have to either decline that project or use a specialist tool with which they might be unfamiliar to author the DVD-Video disc image. It will be appreciated by those skilled in the art that using such an alternative authoring tool could be expensive, time consuming and inefficient as the company may only have one person, or a small number of people, who are familiar with the specialist authoring tool.

It is an object of embodiments of the present invention at least to mitigate some of the problems of the prior art.

### SUMMARY OF INVENTION

In a first aspect of the present invention there is provided an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; and creating an audiovisual product in a predetermined output format, using the AV assets and the expanded intermediate data structure of the nodes and the links, wherein the audiovisual product comprises data representing merged first and second video data. Preferably, the first and second video data are DVD-video zone data.

In one preferred embodiment, the present invention relates to authoring of audiovisual content into a form compliant with a specification for DVD-video and able to be recorded on an optical disc recording medium.

In a second aspect of the present invention there is provided an authoring method for use in creating a DVD-video product, comprising the steps of: creating a plurality of components representing parameterised is sections of audiovisual content, and a plurality of transitions representing movements between components; expanding the plurality of components and the plurality of transitions to provide a set of AV assets and an expanded data structure of nodes and links, where each node is associated with an AV asset of the set and the links represent movement from one node to another; and creating a DVD-video format data structure from the AV assets, using the nodes and links, wherein the DVD-video format data structure comprises data representing merged first and second video data. Preferably, the first and second video data are DVD-video zone data.

In a third aspect of the present invention there is provided an authoring method for use in creating an audiovisual product according to a DVD-video specification, comprising the steps of: generating a set of AV assets each comprising a video object, zero or more audio objects and zero or more sub-picture objects, and an expanded data structure of nodes and links, where each node is associated with one AV asset of the set and the links represent navigational movement from one node to another; and creating a DVD-video format data structure from the set of AV assets, using the nodes and links; the method characterised by the steps of: creating a plurality of components and a plurality of transitions, where a component implicitly defines a plurality of AV assets by referring to a presentation template and to items of raw content substitutable in the presentation template, and the plurality of transitions represent navigational movements between components; and expanding the plurality of components and the plurality of transitions to generate the set of AV assets and the expanded data structure of nodes and links, wherein the set of AV assets and the expanded data structure of the nodes and links comprises data representing merged first and second video data. Preferably, the first and second video data are DVD-video zone data.

In another aspect the present invention there is provided a recording medium having recorded thereon computer executable instructions for performing any of the methods defined herein.

In yet another aspect of the present invention there is provided a recording medium having recorded thereon an audiovisual product authored according to any of the methods defined herein.

Advantageously, embodiments can provide a convenient and simple method and apparatus for authoring an audio-visual product.

Preferred embodiments provide a method and apparatus able to create an audio-visual product having a complex navigational structure and/or having many individual content objects, whilst reducing a time required for authoring and minimising a need for highly skilled operators.

Preferably, there is provided an authoring tool that is intuitive to use and is highly flexible.

Particularly preferred embodiments support creation of audio-visual products such as DVD-video products that run on commonly available DVD-video players.

According to a further aspect of embodiments of the present invention there is provided a method for merging first and second data associated with first and second DVD-Video zone directories respectively; the method comprising the steps of: identifying the registers used by at least one of the first and second data; allocating use of the registers to at least one of the first and second data according to said identifying; and creating data associated with video manager information (VMGI) of the DVD-video disc image data to accommodate at least one of the first and second DVD-Video zones.

Advantageously, multiple authoring tools can be used to create or to author a single DVD-Video disc image or project.

A further advantage of embodiments of the present invention is that multiple authors can collaborate to work on the same project, either using separate copies of the same authoring tool, or using different authoring tools with the end products being merged using embodiments of the present invention.

Preferred embodiments provide a method comprising the step of collating the first and second data to produce DVD-Video data.

At least one of the first and second data comprises at least one of a Group of Picture, a Video Object, a Video Object Set, a Video Object Unit, a Cell, Program, Part_of_Title, Program Chain, Title, Navigation Pack, Video Pack, Audio Pack or DVD-Video disc image data.

Preferably, embodiments provide a method in which the step of creating comprises creating menu data of video manager menu data (video_ts.vob) to access at least one of the first and second data.

Preferred embodiments provide a method further comprising the step of establishing a backup copy of the data associated with the video manager information.

Embodiments provide a method in which the step of establishing a backup copy of the data associated with the video manager information comprises the step of creating VMGI backup information (video_ts.bup).

Preferred embodiments provide a method in which the first and second data were created using respective, different, authoring tools or by different authors using the same tool.

Embodiments provide a method further comprising, prior to the step of identifying, the step of determining whether or not at least one of the first and second data has associated copy protection.

Embodiments are provided in which the step of creating the first data using a respective authoring tool and performing the steps of any preceding claim using that respective authoring tool.

It will be appreciated that embodiments also provide a system for implementing methods described in this specification. Suitably, for example, an aspect of embodiments of the present invention provides a system for merging first and second data associated with first and second DVD-Video zone directories respectively; the system comprising an identifier to identify registers or resources used by at least one of the first and second data; an allocator to allocate use of the registers or resources to at least one of the first and second data according to an output of the identifier; and a creator to create data associated with video manager information (VMGI) of the DVD-video disc image. data to accommodate at least one of the first and second DVD-Video zones. A still further aspect of embodiments of the present invention provides a system for merging first and second data associated with first and second DVD-Video zone directories respectively; the system comprising means to identify the registers used by at least one of the first and second data; means to allocate use of the registers to at least one of the first and second data according to said identifying; and means to create data associated with video manager information (VMGI) of the DVD-video disc image data to accommodate at least one of the first and second DVD-Video zones.

A further aspect of embodiments of the present invention provides a method for merging first and second video data (for example, VTSs); the method comprising the steps of: assessing potential use of a predeterminable resource by at least one of the first and second video data; allocating use of the predeterminable resource to at least one of the first and second video data according to the step of assessing; collating the first and second video data to create DVD-Video data; and creating data associated with video manager information (for example, VMGI) of the DVD-Video data to accommodate at least one of the first and second video data.

Embodiments provide a data processing method in which the predeterminable resource is at least one of GPRM registers, titles and part of titles.

Embodiments can be realised in the form of software. The software can be carried using any appropriate medium such as, for example, optical media like DVD, CD-ROM, magnetic media or using devices like ROMs or other programmable devices. Suitably, embodiments provide a computer program comprising executable code to implement a method or system as described or claimed in this specification. Preferred embodiments provide a computer program product comprising storage storing such a computer program.

Further aspects of embodiments of the present invention provide a method for merging first and second DVD-Video zone directories (VIDEO_TS); the method comprising the steps of: identifying the use of GPRM registers by at least one of the first and second DVD-Video zones; allocating use of the GPRM registers to at least one of the first and second DVD-Video zones according to said identifying; collating the first and second DVD-Video zones to create DVD-video disc image data; and creating data associated with video manager information (VMGI) of the DVD-video disc image data to accommodate at least one of the first and second DVD-Video zones.

### BRIEF DESCRIPTION OF THE DRAWINGS

Embodiments of the present invention will now be descried, by way of example only, with reference to the accompanying drawings in which:

FIG. 1 is an overview of an authoring method according to a preferred embodiment;

FIG. 2 is a schematic diagram showing a simple abstraction of a desired audiovisual product;

FIG. 3 shows in more detail a component used as part of the abstraction of FIG. 2;

FIG. 4 illustrates an example prior art authoring method compared with an example preferred embodiment;

FIG. 5 depicts another example embodiment of the present authoring method using components and transitions;

FIG. 6 shows the example of FIG. 5 in a tabular format;

FIG. 7 is an overview of a method for evaluating components and transitions;

FIG. 8 depicts evaluation of components in more detail;

FIG. 9 shows evaluation of transitions in more detail;

FIG. 10 illustrates a portion of an expanded data structure during evaluation of components and transitions;

FIG. 11 is an overview of a preferred method for creating DVD-video structures from an expanded data structure;

FIG. 12 shows a step of creating DVD video structure locations in more detail;

FIG. 13 depicts a step of creating DVD-video compatible data structures in more detail;

FIG. 14 shows schematically a file structure illustrating the format of the data units forming a DVD-video disc image;

FIG. 15 illustrates schematically incorporation of video title sets into a DVD-Video disc image having a video manager and accompanying video title sets;

FIG. 16 depicts a flowchart for merging DVD-Video according to a first embodiment;

FIG. 17 illustrates an embodiment of the present invention for incorporating a video manager and associated video title sets into further video title sets; and

FIG. 18 shows a flowchart for merging DVD-Video according to a second embodiment.

### DETAILED DESCRIPTION OF THE PREFERRED EMBODIMENTS

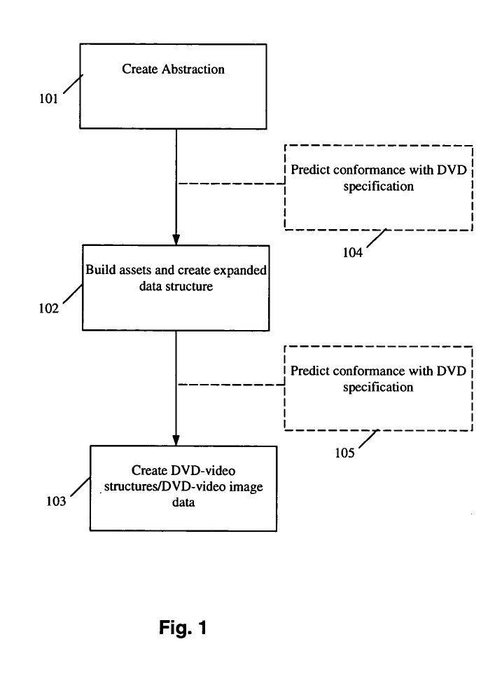

FIG. 1 shows an overview of an authoring method according to a preferred embodiment of the present invention. The embodiments of the present invention are applicable when authoring many types of audiovisual content or products, and in particular when complex navigational structure or content are involved.

As one example, embodiments of the present invention are applicable to authoring of video-on-demand products delivered remotely from a service provider to a user, such as over a computer network or other telecommunications network. Here, the embodiments of present invention are especially useful in authoring interactive products, where user choices and responses during playback of the product dictate navigational flow or content choices.

As another example, embodiments of the present invention are particularly suitable for use in the authoring of an audiovisual product or audio visual content compliant with a DVD-video specification. This example will be discussed in more detail below in order to illustrate the preferred arrangements of present invention. The audiovisual product or content can be, for example, recorded onto a medium such as an optical disk or magnetic medium. The DVD-video specification defines a series of data objects that are arranged in a hierarchical structure, with strict limits on the maximum number of objects that exist at each level of the hierarchy. Hence, in one preferred embodiment of the present invention it is desired to create an audiovisual product or audiovisual content which meets these and other limitations of the specification. In particular it is desired that the resultant audiovisual product or content will play on commonly available DVD players. However, it is also desired to create the audiovisual product or content having a complex navigational structure, to increase a user's enjoyment of the product, and in order to allow the creation of new categories of audiovisual products.

In the field of DVD-video, audiovisual content is considered in terms of audio-visual assets (also called AV assets or presentation objects) . According to the DVD-video specification each AV asset contains at least one video object, zero or more audio objects, and zero or more sub-picture objects. That is, a section of video data is presented along with synchronised audio tracks and optional sub-picture objects. The current DVD-video specification allows up to eight different audio tracks (audio streams) to be provided in association with up to nine video objects (video streams). Typically, the video streams represent different camera angles, whilst the audio streams represent different language versions of a soundtrack such as English, French, Arabic etc. Usually, only one of the available video and audio streams is selected and reproduced when the DVD-video product is played back. Similarly, the current specification allows up to thirty-two sub-picture streams, which are used for functions such as such as language subtitles. Again, typically only one of the sub-picture streams is selected and played back to give, for example, a movie video clip with English subtitles from the sub-picture stream reproduced in combination with a French audio stream. Even this relatively simple combination of video, audio and sub-picture streams requires a high degree of coordination and effort during authoring to achieve a finished product such as a feature movie. Hence, due to the laborious and expensive nature of the authoring process there is a strong disincentive that inhibits the development of high-quality audiovisual products or content according to the DVD-video specification. There is then an even stronger impediment against the development of audiovisual products or content with complex navigational flow or using high numbers of individual raw content objects.

Conveniently, the authoring method of embodiment of the present invention are implemented as a program or a suite of programs. The program or programs are recorded or stored on or in any suitable medium, including a removable storage such as a magnetic disk, hard disk or solid state memory card, or as a signal modulated onto a carrier for transmission on any suitable data network, such as the Internet.

In use, the authoring method is suitably performed on a computing platform, like a general purpose computing platform such as a personal computer or a client-server computing network. Alternatively, the method may be implemented, wholly or at least in part, by dedicated authoring hardware.

As shown in FIG. 1, the authoring method of the preferred embodiment of the present invention comprises three main stages, namely: creating a high-level abstraction (or storyboard) representing functional sections of a desired audiovisual product in step 101; automatically evaluating the high-level abstraction to create a fully expanded intermediate structure and a set of AV assets in step 102; and creating an output data structure compliant with a DVD-video specification using the expanded intermediate structure and AV assets in step 103. Preferably, the output data structure can then recorded onto a recording medium, such as, for example, a digital linear tape that can be used, to create a DVD-video product using glass master created using the content of the digital linear tape.

The method outlined in FIG. 1 will now be explained in more detail.

Firstly, looking at the step 101 of FIG. 1, the high-level abstraction is created by forming a plurality of components that implicitly represent functional elements of a desired DVD-video product or content, and a set of transitions that represent movements, that is, navigation, between the components that will occur during playback.

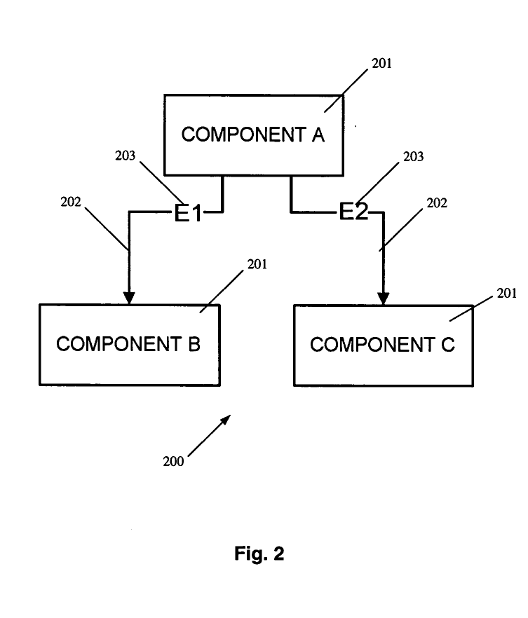

FIG. 2 is a schematic diagram showing a simple abstraction of a desired audiovisual product or content. In the example of FIG. 2 there are three components 201, linked by two transitions 202. The components 201 represent functional elements of the desired audiovisual product, where one or more portions of AV content (combinations of video clips, audio clips, etc) are to be reproduced during playback. The transitions 202 indicate legitimate ways of moving from one component to another during playback. In the example of FIG. 2, the transitions 202 are all explicitly defined. Suitably, each transition 202 is associated with an event 203, which indicates the circumstances giving rise to that transition. An event 203 is a triggering action such as the receipt of a user command, or the expiry of a timer, that influences movement through the sections of AV content during playback. Referring to FIG. 2, starting from a particular component A, and given all possible actions, exactly one event 203 will be satisfied, allowing a transition 202 from the current component A to a next component B or C.

The preferred embodiments provide three different types of component. These are an information component, a choice component and a meta-component.

An information component represents what will in due course become a single AV asset in the desired audiovisual product. Suitably, an information component simply comprises a reference to a raw content object or collection of raw content objects (i.e. raw video and audio clips, image stills or other digital content) that will be used to create an AV asset in the audiovisual product. For example, an information component refers to a welcome sequence that is displayed when the DVD-video product is played in a DVD-video player. The same welcome sequence is to be played each time playback begins. It is desired to display the welcome sequence, and then proceed to the next component. An information component (which can also be termed a simple component) is used principally to define presentation data in the desired DVD-video product.

A choice component represents what will become a plurality of AV assets in the desired audiovisual product. In the preferred embodiment, the choice component (alternately termed a multi-component) comprises a reference to at least one raw content object, and one or more parameters. Here, for example, it is desired to present a welcome sequence in one of a plurality of languages, dependent upon a language parameter. That is, both a speaker's picture (video stream) and voice track (audio stream) are changed according to the desired playback language. Conveniently, a choice component is used to represent a set of desired AV assets in the eventual audiovisual product or content, where a value of one or more parameters is used to distinguish between each member of the set. Hence, a choice component represents mainly presentation data in a desired DVD-video product or content, but also represents some navigational structure (i.e. selecting amongst different available AV assets according to a language playback parameter).

A meta-component comprises a procedurally-defined structure representing a set of information components and/or a set of choice components, and associated transitions. Conveniently, a meta-component may itself define subsidiary meta-components. A meta-component is used principally to define navigational structure in the desired audiovisual product by representing other components and transitions.

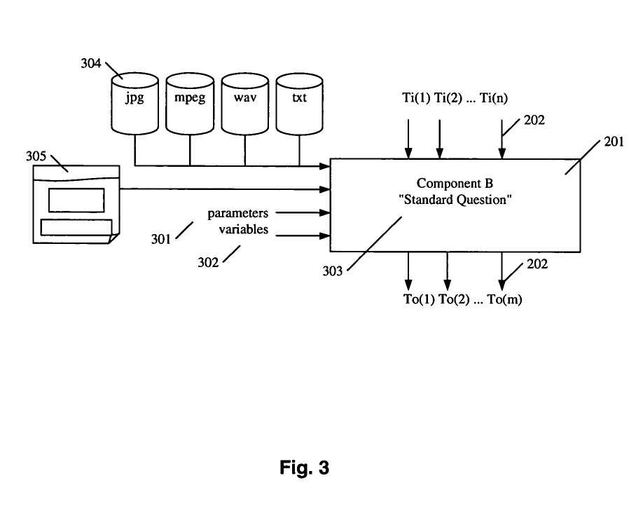

FIG. 3 shows a choice component or information component 201 in more detail. The component is reached by following one of a set of incoming transitions 202, labelled Ti(1 . . . n), and is left by following one of a set of outgoing transitions To(1 . . . m). The set of incoming transitions 202 might comprise one or more than one incoming transition. The set of outgoing transitions might comprise one or more than one outgoing transition.

The component 201 is defined with reference to zero or more parameters 301, which are used only during the authoring process. However, the component 201 may also be defined with reference to zero or more runtime variables 302. Each variable 302 records state information that can be read and modified within the scope of each component, during playback of the audiovisual product or content such as in a standard DVD player. Conveniently, the component 201 is provided with a label 303 for ease of handling during the authoring process.

The component 201 contains references to one or more items of content 304. The items of content are raw multi-media objects (still picture images, video clips, audio clips, text data, etc.) recorded in one or more source storage systems such as a file system, database, content management system, or asset management system, in any suitable format such as, for example, .gif, .tif, .bmp, .txt, .rtf, .jpg, mpg, .qtf, .mov, .wav, .rm, .qtx, amongst many others. It will be appreciated that these raw content objects are not necessarily at this stage in a format suitable for use in the DVD-video specification, which demands that video, audio and sub-picture objects are provided in selected predetermined formats (i.e. MPEG).

Each component 201 uses the references as a key or index which allows that item of content to be retrieved from the source storage systems. The references may be explicit (e.g. an explicit file path), or may be determined implicitly, such as with reference to values of the parameters 301 and/or variables 302 (i.e. using the parameters 301 and/or variables 302 to construct an explicit file path).

Conveniently, the component 201 also preferably comprises a reference to a template 305. The template 305 provides, for example, a definition of presentation, layout, and format of a desired section of AV content to be displayed on screen during playback. A template 305 draws on one or more items of content 304 to populate the template. Typically, one template 305 is provided for each component 201. However, a single template 305 may be shared between a number of components 201 or vice versa. A template 305 is provided in any suitable form, such as, for example. As an executable program, a plug-in or an active object. A template is conveniently created using a programming language such as C++, Visual Basic, Shockwave or Flash, or by using a script such as HTML or Python, amongst many others. Hence, it will be appreciated that a template allows a high degree of flexibility in the creation of AV assets for a DVD-video product or content. Also, templates already created for other products (such as a website) may be reused directly in the creation of another form of audiovisual product or content, in this case a DVD-video product content.

The parameters 301, runtime variables 302, content items 304 and template 305 together allow one or more AV assets to be produced for use in the desired audiovisual product. Advantageously, creating a component 201 in this parameterised form allows a number, which might be a large number, large plurality of AV assets to be represented simply and easily by a single component.

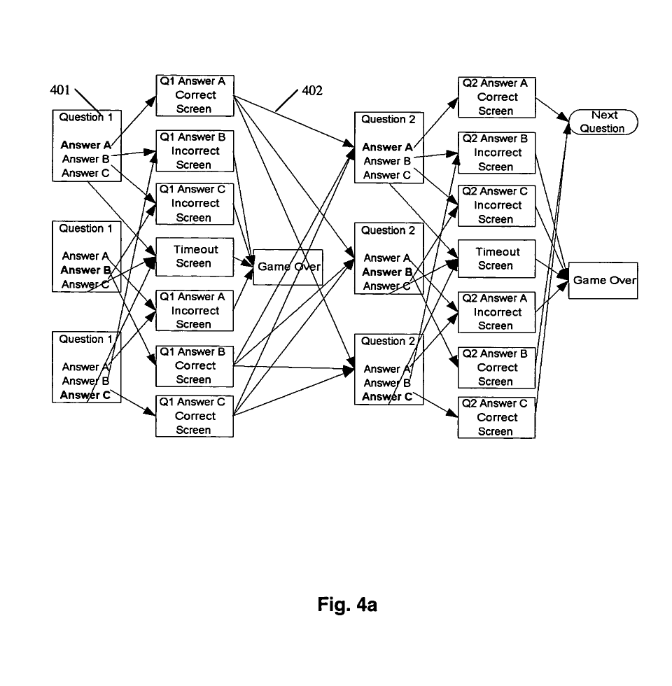

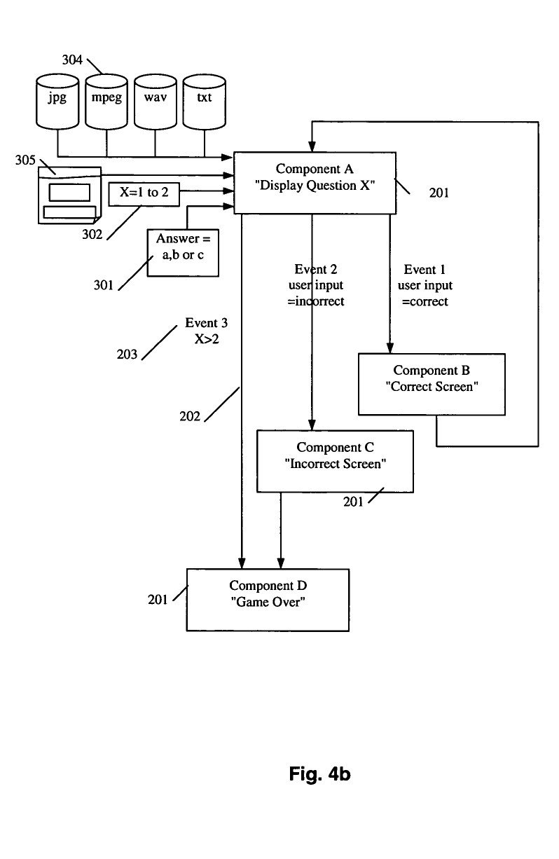

To illustrate the power and advantages of creating components 201 and transitions 202 as described above, reference will now be made to FIG. 4 which compares a typical prior art method for authoring an audiovisual product or content against preferred embodiments of the present invention. In this example, it is desired to develop an audiovisual product which allows the user to play a simple quiz game.

In FIG. 4a, each AV asset 401 which it is desired to present in the eventual audiovisual product must be created in advance and navigation between the assets defined using navigation links represented by arrows 402. Here, the game involves answering a first question and, if answered correctly, then answering a second question. The answer to each question is randomised at runtime using a runtime variable such that one of answers A, B and C is correct, whilst the other two are incorrect. In this simple example of FIG. 4a it can be seen that a large number of assets need to be created, with an even greater number of navigational links. Hence, the process is relatively expensive and time consuming, and is prone to errors.

FIG. 4b shows an abstraction, using components and transitions as described herein, for an equivalent quiz game. It will be appreciated that the abstraction shown in FIG. 4b remains identical even if the number of questions increases to ten, twenty, fifty or some other number of questions, whereas the representation in FIG. 4a becomes increasingly complex as each question is added.

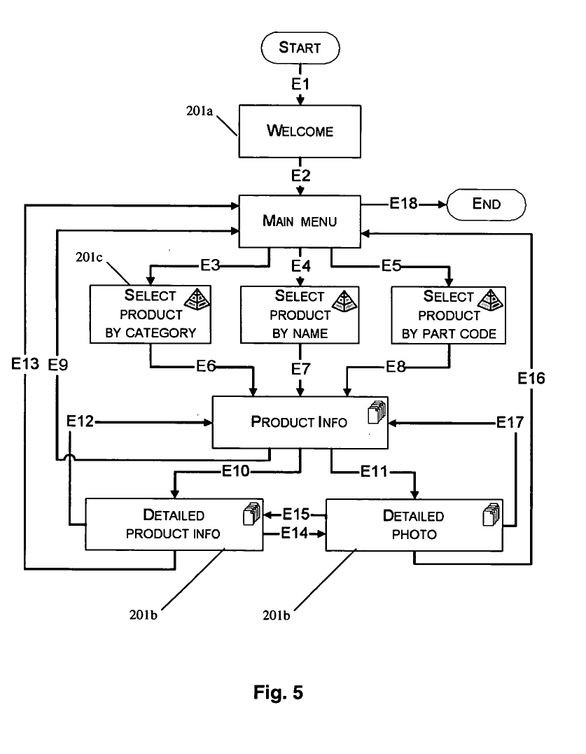

FIG. 5 shows another example abstraction using components and transitions. FIG. 5 illustrates an example abstraction for an audiovisual product or content that will contain a catalogue of goods sold by a retail merchant. A welcome sequence is provided as an information component 201a. Choice components 201b are used to provide a set of similar sections of AV content such as summary pages of product information or pages of detailed product information including photographs or moving video for each product in the catalogue. Here, the catalogue contains, for example, of the order of one thousand separate products, each of which will result in a separate AV asset in the desired DVD-video product. Meta-components 201c provide functions such as the selection of products by category, name or by part code. These meta-components are procedurally defined.

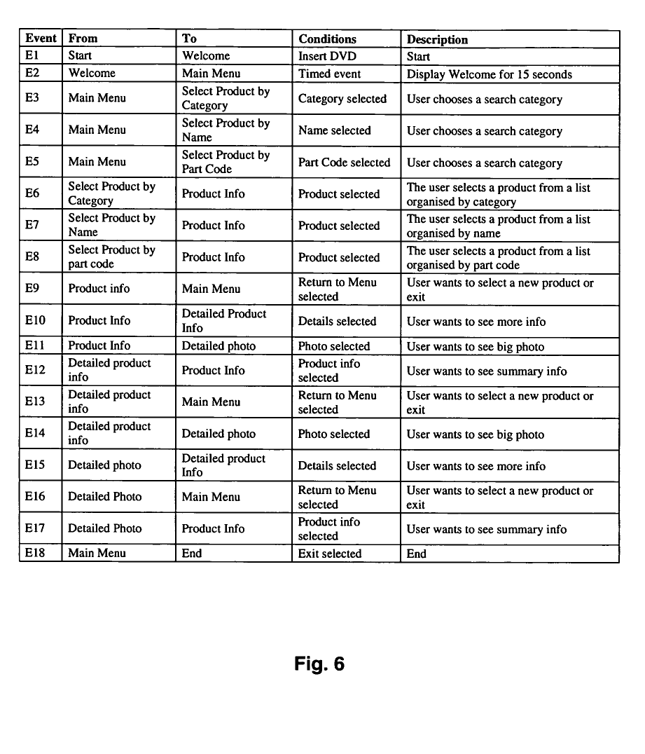

FIG. 6 shows a tabular representation for the abstraction shown in schematic form in FIG. 5.

In use, the authoring method and apparatus suitably presents a convenient user interface for creating components and transitions of the high-level abstraction. Ideally, a graphical user interface is provided allowing the definition of components, transitions and events, similar to the schematic diagram of FIG. 5. Most conveniently, the user interface provides for the graphical creation of components such as by drawing boxes and entering details associated with those boxes, and defining transitions by drawing arrows between the boxes and associating events with those arrows. Alternatively, a tabular textual interface is provided similar to the table of FIG. 6.

Referring again to FIG. 1, the abstraction created in step 101 is itself a useful output. The created abstraction may be stored for later use or may be transferred to another party for further work. However, in most cases the authoring method is used to automatically create a final audiovisual product or content, such as a DVD-video product, from the abstraction.

Referring to FIG. 1, the method optionally includes the step 104 of checking for compliance with a DVD specification. It is desired to predict whether the resulting DVD-video product will conform to a desired output specification, in this case the DVD-video specification. For example, the DVD-video specification has a hierarchical structure with strict limits on a maximum number of objects that may exist at each level, and limits on the maximum quantity of data that can be stored on a DVD-video disc.

In one embodiment, the checking step 104 is performed using the created components 201 and transitions 202. As discussed above, the components 201 contain references to raw AV content objects 304 and templates 305, and authoring parameters 301, 302, that allow AV assets to be produced. The checking step 104 comprises predicting a required number of objects at each level of the hierarchical structure, by considering the number of potential AV assets that will be produced given the possible values of the authoring parameters (i.e. authoring-only parameters 301 and runtime variables 302), and providing an indication of whether the limits for the maximum number of objects will be exceeded. Similarly, where a component defines a set of similar AV assets, then it is useful to predict the physical size of those assets and to check that the audiovisual product or content is expected to fit within the available capacity of a DVD disc. Advantageously, the conformance check of step 104 is performed without a detailed realisation of every AV asset, whilst providing an operator with a reasonably accurate prediction of expected conformance. If non-conformance is predicted, the operator may then take steps, at this early stage, to remedy the situation. As a result, it is possible to avoid unnecessary time and expense in the preparation of a full audiovisual product which is non-conformant.

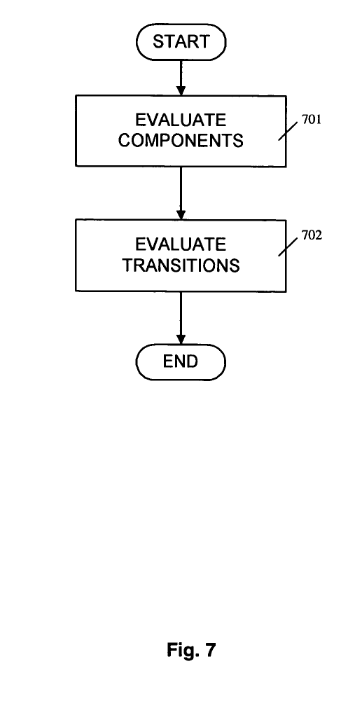

As shown in FIG. 1, in step 102 the components 201 and transitions 202 of the high level abstraction 200 are automatically evaluated and expanded to create AV assets and an intermediate data structure of nodes and links. FIG. 7 shows the step 102 of FIG. 1 in more detail.

The components 201 and transitions 202 may be evaluated in any order. However, but it is convenient to first evaluate the components and then to evaluate the transitions. Ideally, any meta-components in the abstraction are evaluated first. Where a meta-component results in new components and transitions, these are added to the abstraction until all meta-components have been evaluated, leaving only information components and parameterised choice components.

An expanded intermediate data structure is created to represent the abstract components 201 and transitions 202 in the new evaluated form. This expanded data structure comprises branching logic derived from the events 203 attached to the transitions 202 (which will eventually become navigation data in the desired audiovisual product or content) and nodes associated with AV assets derived from the components 201 (which will eventually become presentation data in the audiovisual product or content). However, it is not intended that the expanded data structure is yet in a suitable form for creating an audiovisual product in a restricted format such as a DVD-video product, since at this stage there is no mapping onto the hierarchical structure and other limitations of the DVD-video specification.

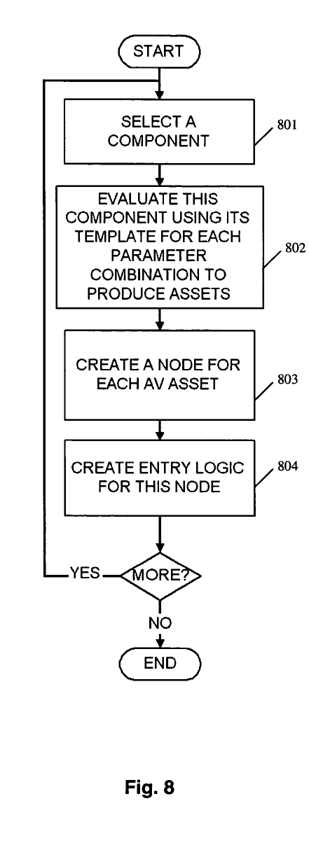

FIG. 8 shows step 701 of FIG. 7 in more detail, to explain the preferred method for evaluating the components 201. As shown in FIG. 8, each information component 201a and each choice component 201b is selected in turn in step 801. Each component 201 is evaluated to provide one or more AV assets in step 802. In an information component, this evaluation comprises creating an AV asset from the referenced raw content objects 304. In a choice component, this evaluation step comprises evaluating a template 305 and one or more raw content objects 304 according to the authoring parameters 301/302 to provide a set of AV assets. Suitably, a node in the expanded data structure is created to represent each AV asset, at step 803. At step 804, entry logic 132 and/or exit logic 134 is created to represent a link to or from each node such that each AV asset is reached or left under appropriate runtime conditions.

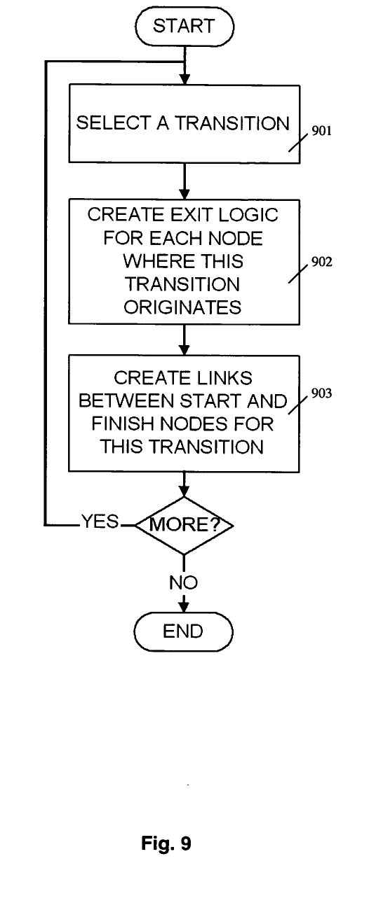

FIG. 9 shows a preferred method for evaluating transitions in step 702 of FIG. 7. Each transition 202 is selected in any suitable order in step 901. In step 902 the conditions of the triggering event 203 associated with a particular transition 202 are used to create entry and/or exit logic for each node of the expanded data structure. In step 903, explicit links are provided between the nodes.

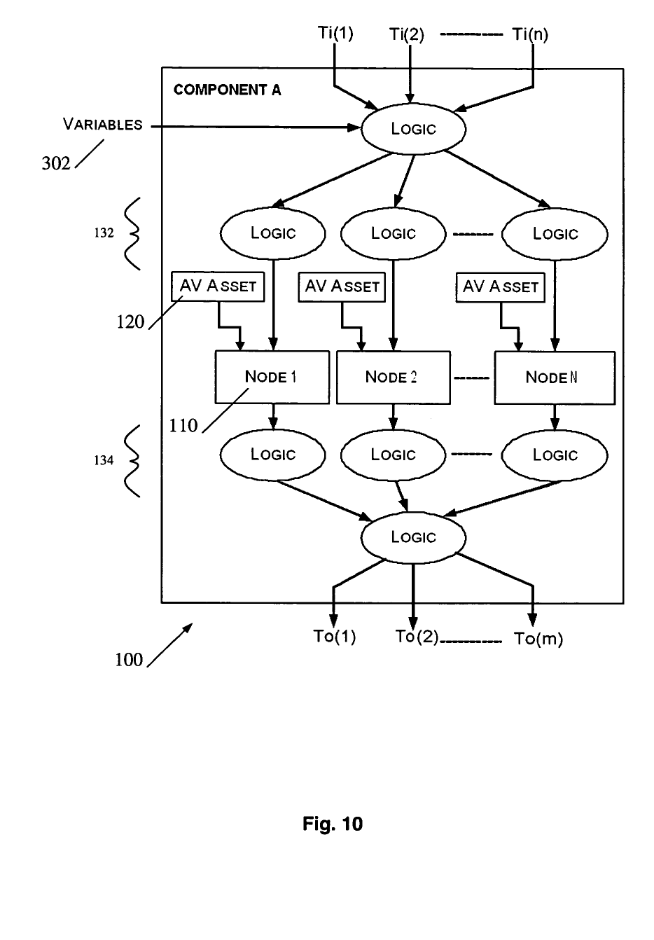

FIG. 10 is a schematic illustration of a component 201 during evaluation to create a set of nodes 110 each associated with an AV asset 120, together with entry logic 132 and exit logic 134, defining movement between one node 110 and the next. The entry logic 132 and exit logic 134 reference runtime variables 302 which are available during playback (e.g. timer events, player status, and playback states), and the receipt of user commands. Conveniently, the evaluation step consumes each of the authoring-only parameters 301 associated with the abstract components 201, such that only the runtime variables 302 and runtime actions such as timer events and user commands remain.

Referring again to FIG. 1, a conformance checking step 105 may, additionally or alternatively to the checking step 104, be applied following the evaluation step 102. Evaluation of the abstraction in step 102 to produce the expanded data structure 100 allows a more accurate prediction of expected compliance with a particular output specification. In particular, each node of the expanded data structure represents one AV asset, such that the total number of AV assets and object locations can be accurately predicted, and the set of AV assets has been created, allowing an accurate prediction of the capacity required to hold these assets. Conveniently, information about conformance or non-conformance is fed back to an operator. Changes to the structure of the product can then be suggested and made in the abstraction to improve compliance.

Referring to FIG. 1, in step 103 the expanded data structure from step 102 is used to create an audiovisual product according to a predetermined output format, in this case by creating specific structures according to a desired DVD-video specification.

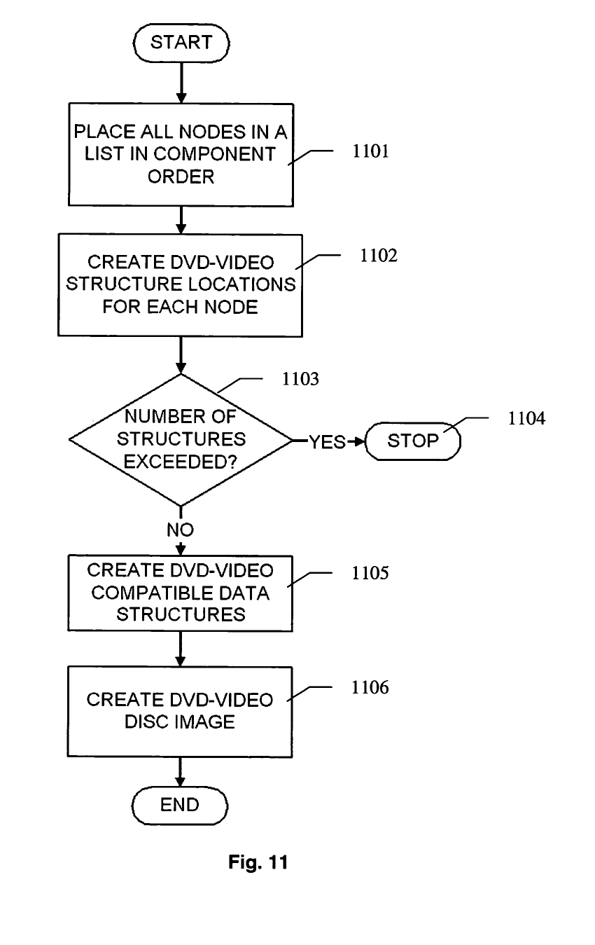

FIG. 11 shows an example method for creation of the DVD video structures. In step 1101, the nodes 110 in the expanded data structure are placed in a list, such as in an order of the abstract components 201 from which those nodes originated, and in order of the proximity of those components to adjacent components in the abstraction. As a result, jumps between DVD video structure locations during playback are minimised and localised to improve playback speed and cohesion.

Each node is used to create a DVD video structure location at step 1102. Optionally, at step 1103 if the number of created DVD video structure locations exceeds the specified limit set by the DVD-video specification then creation is stopped at 1104 and an error reported. Assuming the number of structures is within the specified limit then DVD video compatible data structures are created at step 1105. Finally, a DVD video disc image is created at step 1106. Conveniently, commercially available tools are used to perform step 1106 and need not be described in detail here.

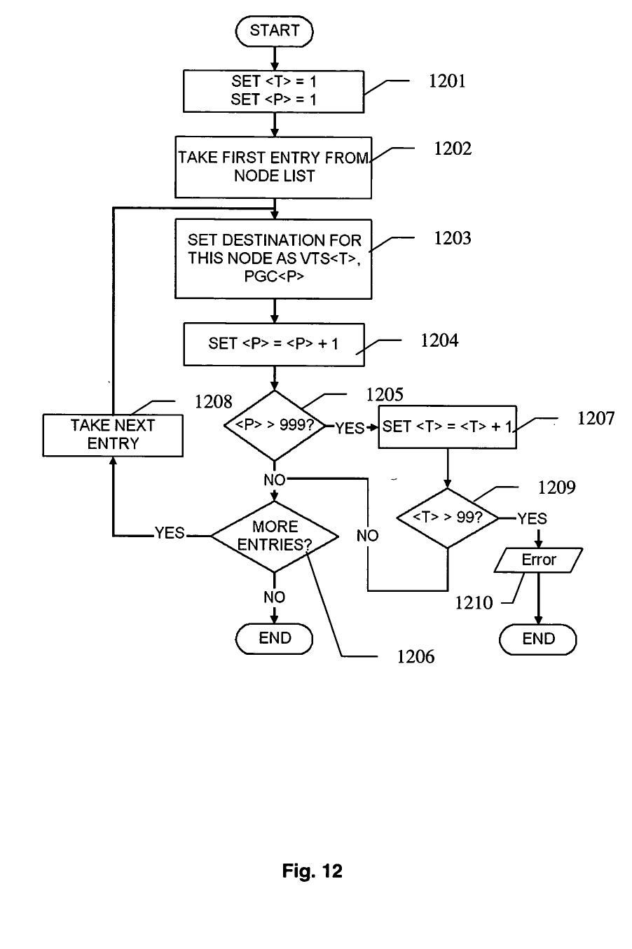

Step 1102 is illustrated in more detail in FIG. 12. In this example variable T represents a number of a video title set VTS (ie. from 1-99) whilst variable P represents a program chain PGC (ie. from 1-999) within each video title set. As shown in FIG. 12, the nodes 110 of the expanded data structure 100 are used to define locations in the video title sets and program chains. As the available program chains within each video title set are consumed, then the locations move to the next video title set. Here, many alternate methods are available in order to optimise allocation of physical locations to the nodes of the expanded data structure.

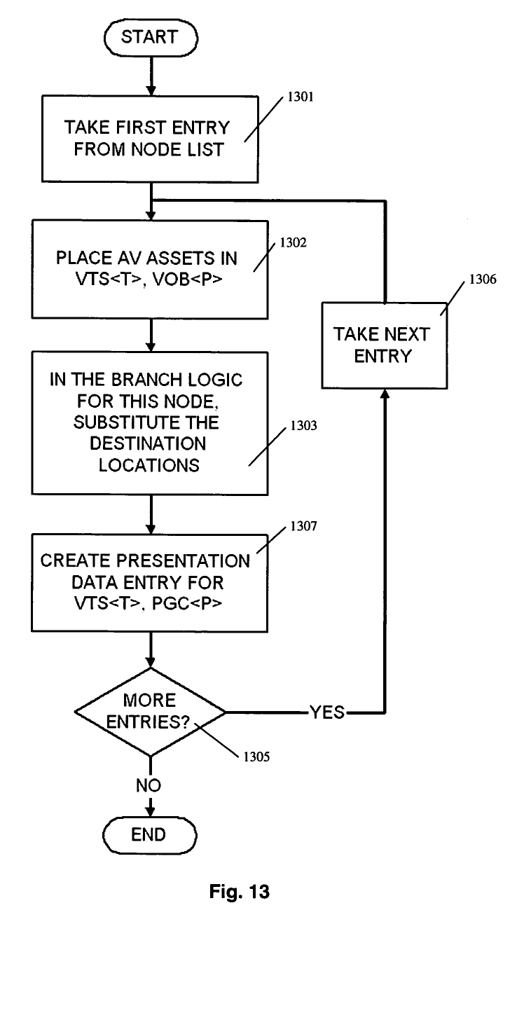

Step 1105 of FIG. 11 is illustrated in more detail in FIG. 13. FIG. 13 shows a preferred method for creating DVD-video compatible data structures by placing the AV assets 120 associated with each node 110 in the structure location assigned for that node and substituting links between the nodes with explicit references to destination locations. At step 1307 this results in an explicit DVD compatible data structure which may then be used to create a DVD disc image. Finally, the DVD disc image is used to record a DVD disc as a new audiovisual product.

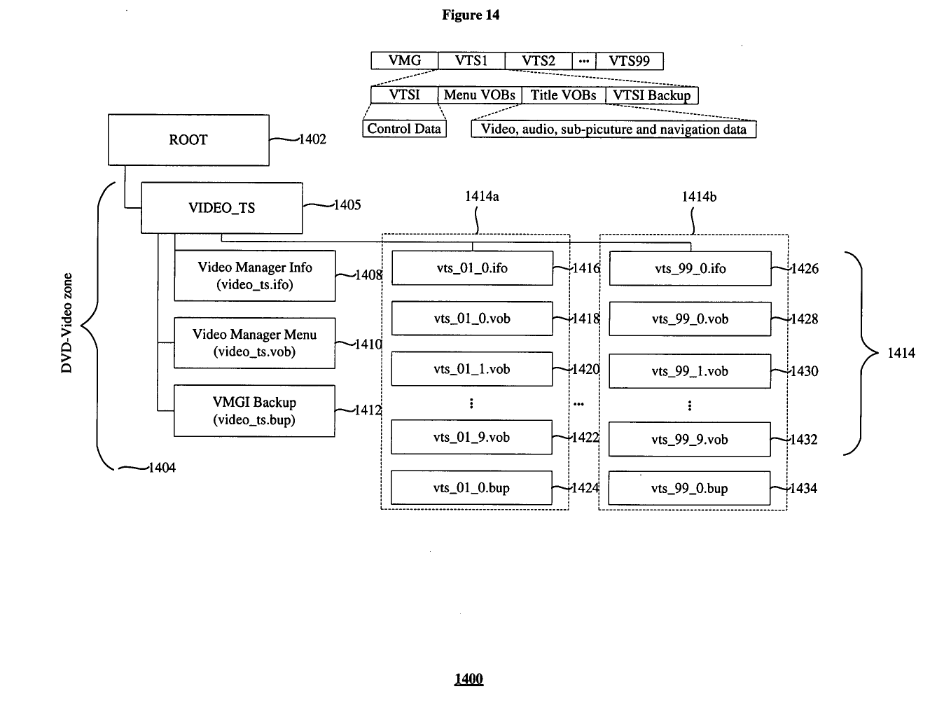

Referring to FIG. 14 there is shown schematically a file structure 1400 of a DVD-video file system. It can be appreciated that a root node 1402 has a DVD-Video zone 1404. The DVD-Video zone 1404 has a folder or directory named VIDEO_TS 1405 comprising information in the form of video manager information 1408. The video manager information 1408 comprises data representing or associated with a video manager (VMG) or from which such a VMG can be derived. The video manager information 1408 has associated video manager menu information 1410 that, typically, contains the initial menu presented to a user upon inserting a DVD into a DVD player. Also illustrated is the conventional video manager information (VMGI) back-up 1412. The DVD-Video zone 1404 comprises data 1414 representing video title sets (VTS1 to VTS99) that contain control data, menu data, title VOBs (Video Objects comprising MPEG encoded video data, audio data, sub-picture data and navigation information) and backup information. It can be appreciated that a number of video title sets VTS1 to VTS99 comprising such data are illustrated. The data 1414 representing each video title set of such video title sets VTS1 to VTS99 are represented by data arranged in groups of files. It will be appreciated that two groups of data 1414a and 1414b, representing two video title sets VTS1 and VTS99, are illustrated.

The groups of data 1414a and 1414b representing the video title sets VTS1 to VTS99 comprise files 1416 and 1426 containing, or representing, video title set information (VTSI), having control data, files 1418 and 1428 representing, or containing, video object sets for menu, if appropriate, of corresponding video title sets VTS1 to VTS99, files representing 1420 to 1422 and 1430 to 1432, or containing data for, a number of title video objects (Title VOBs), which contain the video, audio, sub-picture data and navigation data, and files 1424 and 1434 containing data representing video title set back-up information (VTSI Backup). The file system 1400 illustrated in FIG. 14 is used by the presentation engine and the navigation manager to render video and audio in accordance with signals received from a remote control when playing a DVD.

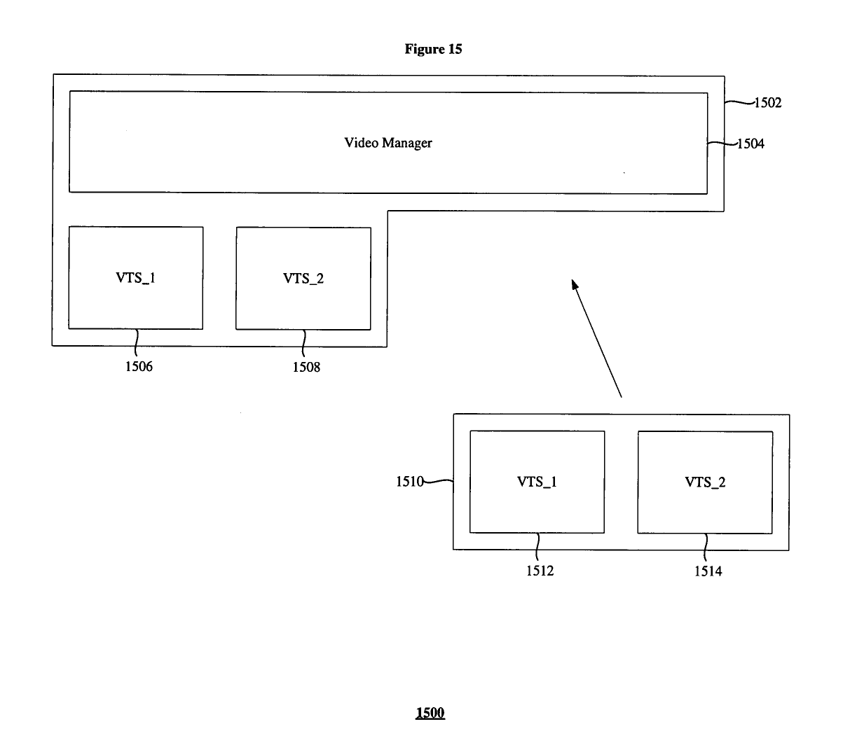

Referring to FIG. 15, there is shown schematically a process 1500 for merging DVD-Video data according to a first embodiment. It can be appreciated that a first set of DVD-video data 1502 comprises a video manager 1504 and associated first and second video title sets 1506 and 1508. It will be appreciated that the first set 1502 of DVD-Video data has been shown as comprising two VTSs. However, any other number, up to a maximum of 99 VTSs with current technology, could equally well be used by embodiments. In the example illustrated, it is desired to incorporate a second set 1510 of video title sets, comprising, for illustrative purposes only, two video title sets 1512 and 1514 authored by a different authoring tool or a different author using the same authoring tool to the one used to produce the first set of DVD-video image data 1502. It will be appreciated that any other number of VTSs could be merged into the first set 1502 according to requirements, up to a maximum of 99 according to the limits of current technology. It will be appreciated that the plurality of components described above comprises a component representing or associated with the first set 1502 DVD-video data. Furthermore, in preferred embodiments, the first 1502 set of DVD-video data is an embodiment of a raw content object described above, while the second set 1510 of DVD-video data is preferably native to, that is, produced by, the tool performing the incorporation.

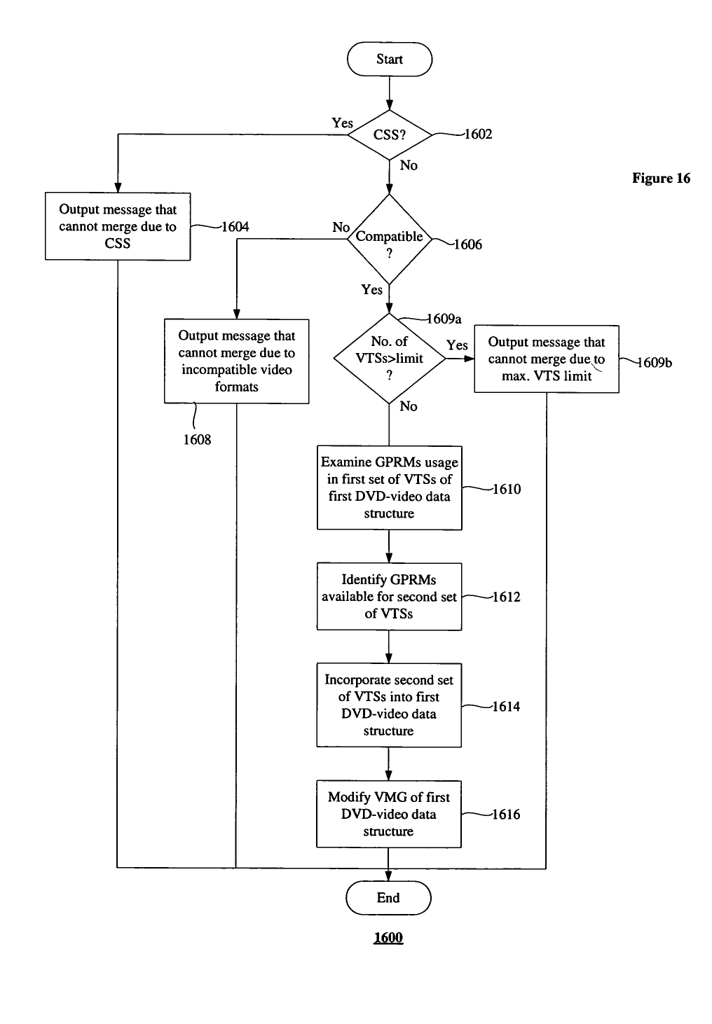

Referring to FIG. 16, there is shown a flowchart 1600 for incorporating the second set 1510 of video title sets 1512 and 1514 into the DVD-Video data 1502 according to an embodiment. At step 1602, a determination is made as to whether or not the second set 1510 of DVD-Video data or the first set 1502 of DVD-Video image data has been subjected to some form of content protection such as, for example, the protection provided by a Content Scrambling System (CSS). If the determination at step 1602 is that content protection (CSS) is effective, processing terminates with an optional message being output at step 1604 indicating that the two sets of DVD-Video data 1502 and 1510 cannot be merged due to content protection being effective.

However, if the determination at step 1602 is that content protection is not effective, or has not been applied to either of the DVD-Video data sets 1502 and 1510, a check is made at step 1606 to determine if the video contained within the video title sets 1506, 1508, 1512 and 1514 is compatible, that is, a check is performed to ensure that they all conform to one of the NTSC or PAL standards. If the determination at step 1606 shows that the video contained within, or represented by, the video title sets 1506, 1508, 1512 and 1514 are incompatible, a message is output at step 1608 to that effect and processing terminates.

However, if the video contained within, or represented by, the video title sets 1506, 1508, 1512 and 1514 are compatible, processing proceeds to step 1609a, where it is determined if the total number of VTSs in the resulting merged DVD-video data would exceed a predetermined limit, which is 99 according to current technology, but which could equally well be some other limit. If it is determined that the total number of VTSs would exceed the predetermined limit, a message to that effect is output at step 1609b. If it is determined that the total number of VTSs would not exceed the predetermined limit, processing proceeds to step 1610 where the use of the general parameters registers (GPRMs) of the first 1506 and second 208 video title sets of the first set 1502 of DVD-Video data is determined.

At step 1612, the GPRM registers not used by the first 1506 and second 1508 video title sets are deemed to be available for use by the first 1512 and second 1514 video title sets of the second set 1510 of DVD-Video data.

The first 1512 and second 1514 video title sets of the second set 1510 of DVD-Video image data are incorporated into or integrated into the first set 1502 of DVD-Video image data at step 1614. The video manager 1504 is amended, at step 1616, to include references to the newly incorporated first 1512 and second 1514 video title sets to allow those video title sets to be accessed in an appropriate manner from a menu, if provided, associated with the video manager 1504. It will be appreciated that such references represent embodiments of the plurality of transitions described above, which would map to corresponding links during expansion. Steps 1614 and 1616 might be realised, for example, by copying files representing, or associated with, the first 1512 and second 1514 VTSs into an output area used by an authoring tool for authoring operations, and by adding to the VMG 1504 of the first set of DVD-Video data 1502 (contained in VIDEO_TS.IFO and VIDEO_TS.BUP) attributes of, or associated with, the new VTSs 1512 and 1514.

It will be appreciated by those skilled in the art that step 1614 comprises identifying the appropriate entry points and exit points for the first 1512 and second 1514 video title sets of the second set 1510 of DVD-Video image data. Still further, the incorporation performed at step 1614 comprises the step of modifying the exit points of the first 1512 and second 1514 video title sets of the second set 1510 of DVD-video image data so that control is returned to the video manager 1504 as appropriate. It will be appreciated by those skilled in the art that the entry and exit points are embodiments of the transitions described above and that they will be mapped to links of the expanded intermediate data structure described above.

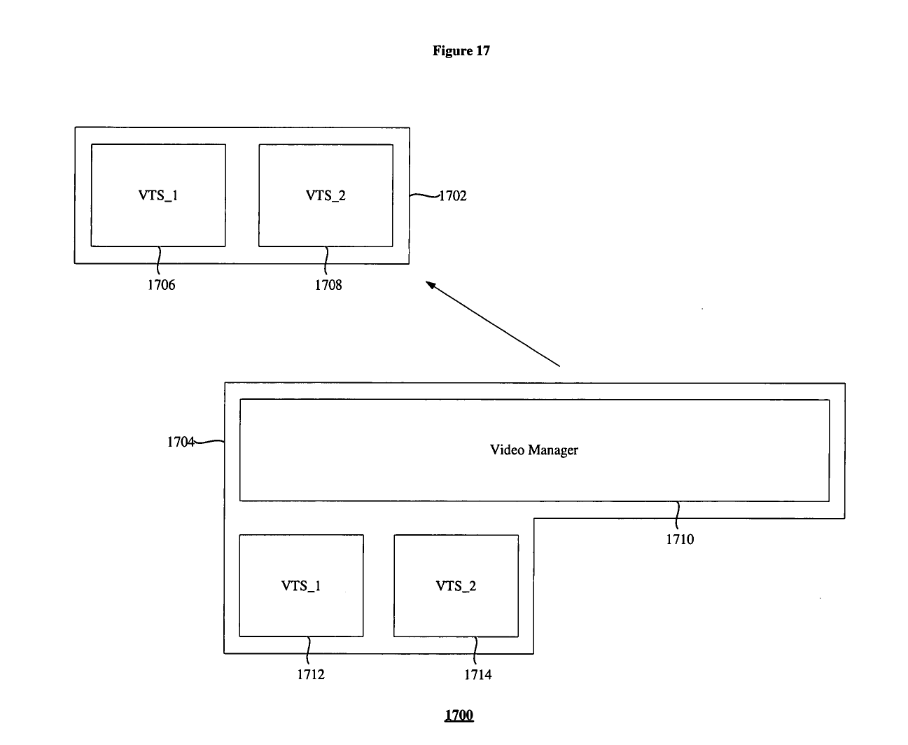

Referring to FIG. 17, there is shown schematically the construction 1700 of DVD-Video data from a first set 1702 of DVD-Video data produced using a respective authoring tool and a second set 1704 of DVD-Video data produced using a different authoring tool or using a copy of the same authoring tool used by a different author. It can be appreciated that the first set 1702 of DVD-Video data comprises first 1706 and second 1708 video title sets. Again, it will be appreciated that two VTSs have been shown for illustrative purposes only. Any number of VTSs could be processed in practice, subject to limits imposed by technical standards that might prevail from time to time. The second set 1704 of DVD-Video data comprises a video manager 1710 and respective first 1712 and second 1714 video title sets. Once again, two VTSs have been used for illustrative purposes only. In the embodiment shown, the second set 1704 of DVD-Video data is incorporated into the first set 1702 of DVD-video image data. Again, in preferred embodiments, it will be appreciated that the first 1702 set of DVD-video data is an embodiment or realisation of a raw content object described above, which can be represented by an associated component of the plurality of components, while the second set of video data is native to, that is, produced by the tool used to perform the incorporation.

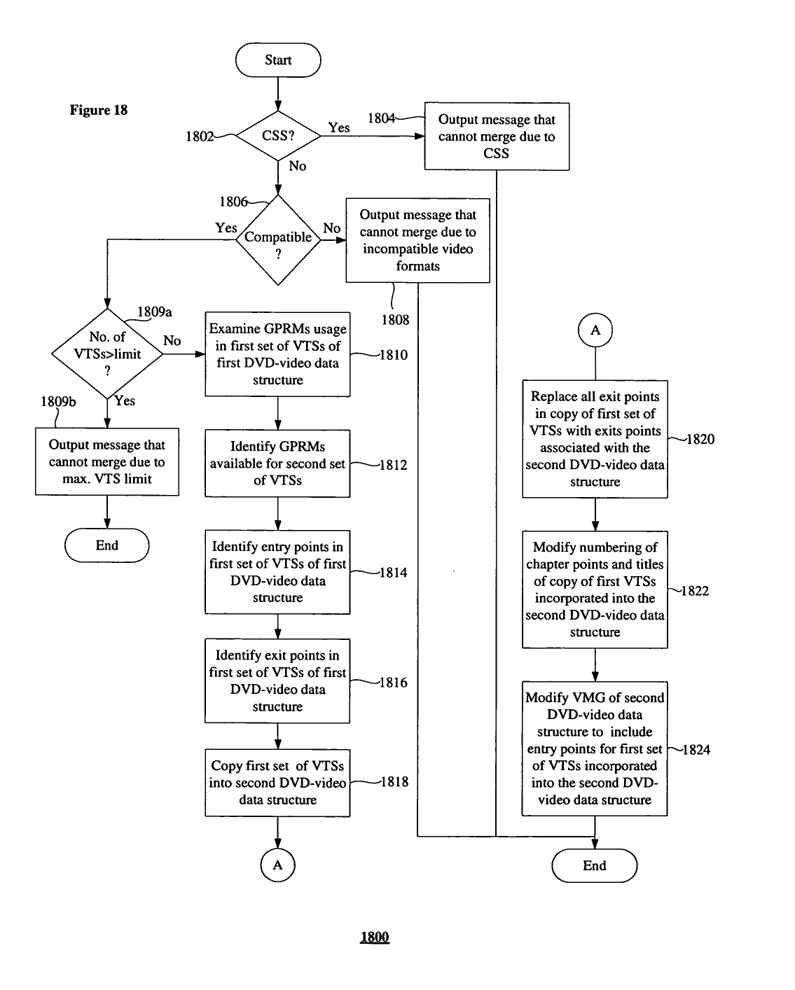

FIG. 18 shows a flowchart 1800 for giving effect to the combination or incorporation illustrated by the embodiment shown in FIG. 17. A determination is made at step 1802 as to whether or not content protection is effective in respect of either of the first set 1702 or second set 1704 of DVD-Video data. If it is determined that such content protection is effective, processing passes to step 1804 where a message indicating that the DVD-Video data sets 1702 and 1704 cannot be merged or combined due to content protection being effective.

If the determination at step 1802 is that content protection is not effective, processing proceeds to step 1806 where it is determined whether or not the video represented by, or contained within, the video title sets 1706, 1708, 1712 and 1714 are compatible, that is, whether or not they are all NTSC video or all PAL video, for example. If the determination at step 1806 is that the video represented by, or contained within, the video title sets 1706 to 1714 are incompatible, a message is output to that effect at step 1808 together with an indication that the merging or combining process cannot be completed.

If the determination at step 1806 is that the video standards are compatible, processing proceeds to step 1809a, where it is determined if the total number of VTSs in the resulting merged DVD-video data would exceed a predetermined limit, which is 99 according to standards applicable to current technology, but which could equally well be some other limit. If it is determined that the total number of VTSs would exceed the predetermined limit, a message to that effect is output at step 1809b. If it is determined that the total number of VTSs would not exceed the predetermined limit, processing proceeds to step 1810 where the use of the GPRM registers of the first set 1702 of DVD-video data is determined. The registers not used by the first set 1702 of DVD-Video data are identified at step 1812 as being available for use by the second set 1704 of DVD-Video data. The entry points in the first set 1702 of DVD-Video data are determined, that is, the entry points for the first 1706 and second 1708 video title sets are determined at step 1814. Furthermore, at step 1816, the exit points for the first 1706 and second 1708 video title sets of the first set 1702 of DVD-Video image are identified.

The first set 1702 of DVD-Video data is copied into, or combined with, the second set 1704 of DVD-Video data at step 1818. All exit points in the VTSs of the first set 1704 of DVD-Video data are replaced with navigation data that returns control to the video manager 1710 of the second set 1704 of DVD-Video data at step 1820.

At step 1822, the navigation data associated with the video manager 1710 for accessing the first 1706 and second 1708 video title sets of the first set 1702 of DVD-video image data are included in the video manager 1710 or, more specifically, in the VMGI of the video manager 1710 (contained in VIDEO_TS.IFO).

It will be appreciated by one skilled in the art that modifying the VMGI comprises establishing appropriate start sector addresses to allow a navigation manager to identify the start sector addresses or entry points for the newly added video title sequences. In practice such modifications entail doing a search-and-replace operation. The instructions that cause control to jump from one place to another are relative, if the jump is within a current VTS, and absolute if the jump is outside a current VTS. Thus, any jumps to outside of a current VTS must be reassigned to fit in with the new combined structure. Again, it will be appreciated that the entry and exits points, that is, navigation data, represent embodiments of the links of the expanded intermediate data structure described above that are derived from corresponding transitions. In the above embodiments, the incorporation is performed preferably using the authoring tool used to produce the second set 1510 or 1704 of DVD-Video data.

The DVD authoring method and apparatus described above have a number of advantages. Creating components that represent parameterised sections of audio visual content allow many individual AV assets to be implicitly defined and then automatically created. Repetitive manual tasks are avoided, which were previously time consuming, expensive and error-prone. The authoring method and apparatus significantly enhance the range of features available in existing categories of audiovisual products or content such as movie presentations. They also allow new categories of audiovisual products or content to be produced. These new categories include both entertainment products or content such as quiz-based games and puzzle-based games, as well as information products such as catalogues, directories, reference guides, dictionaries and encyclopaedias. In each case, the authoring method and apparatus described herein allow full use of the video and audio capabilities of DVD specifications such as DVD-video. A user may achieve playback using a standard DVD player with ordinary controls such as a remote control device. A DVD-video product having highly complex navigational content is readily created in a manner which is simple, efficient, cost effective and reliable.

Although a few preferred embodiments have been shown and described, it will be appreciated by those skilled in the art that various changes and modifications might be made without departing from the scope of the invention, as defined in the appended claims.

The audiovisual content comprises at least any one of data representing audiovisual content, DVD video disc image data or other data compliant with the DVD specification or a medium storing such data

Although the above embodiments have been described with reference to the product or content being playable by a “standard DVD player”, it will be appreciated that other players can equally well be accommodated such as, for example, software players, set-top boxes or other means of processing or otherwise rendering audiovisual products using hardware or software or a combination of hardware and software.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An authoring method for use in creating an audiovisual product or content, comprising the steps of:
defining a plurality of components, the components implicitly representing functional sections of audiovisual content with respect to one or more raw content objects, and a plurality of transitions that represent movements between the plurality of components;
processing the plurality of components and the plurality of transitions to provide at least an intermediate data structure of nodes and links, where each node is associated with one or more of the raw content objects and the links represent movement from one node to another; and
creating an audiovisual product or content in a predetermined output format, using the raw content objects and the intermediate data structure of the nodes and the links.

2. An authoring method as claimed in claim 1, in which the step of processing comprises the step of producing an explicitly realised set of AV assets and respective nodes and links within the intermediate data structure in response to assessing the type of the one or more raw content objects.

3. An authoring method as claimed in claim 1 in which at least one node associated with one or more raw content objects comprises a reference to the one or more raw content objects.

4. An authoring method for use in creating an audiovisual product, comprising the steps of: defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realised AV assets and an expanded intermediate data structure of nodes and links, where each node is associated with an AV asset of the set and the links represent movement from one node to another and where at least one of the nodes being associated with reference to a predetermined raw content object; and
creating an audiovisual product or content in a predetermined output format, using the AV assets, the expanded intermediate data structure of the nodes and the links, and the predetermined raw content object.

5. An authoring method for use in creating an audiovisual product or content, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realized AV assets and an expanded intermediate data structure of nodes and links, where each node is associated with an AV asset of the set and the links represent movement from one node to another; and creating a first portion of audiovisual product in a predetermined output format, using the AV assets and the expanded intermediate data structure of the nodes and the links, and creating a second portion of the audiovisual product using a predetermined one of the raw content objects.

6. An authoring method for use in creating an audiovisual product or content, comprising the steps of:
defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realised AV assets and an expanded intermediate data structure of nodes and links, where each node is associated with an AV asset of the set and the links represent movement from one node to another; and
creating an audiovisual product or content in a predetermined output format, using the AV assets and the expanded intermediate data structure of the nodes and the links, wherein the audiovisual product comprises data representing merged first and second video data.

7. The method of claim 1, wherein the defining step comprises defining at least one information component that comprises a reference to a raw content object.

8. The method of claim 7, wherein the reference denotes a file path to a location where the raw content object is stored.

9. The method of claim 1, wherein the defining step comprises defining at least one choice component comprising a reference to at least one raw content object, and at least one authoring parameter.

10. The method of claim 9, wherein the at least one authoring parameter is adapted to control a selection or modification of the at least one raw content object.

11. The method of claim 9, wherein the at least one authoring parameter comprises a runtime variable available during playback of the audiovisual product.

12. The method of claim 9, wherein the at least one authoring parameter comprises an authoring-only parameter that will not be available during playback of the audiovisual product.

13. The method of claim 9, wherein the choice component comprises a reference to a presentation template and a reference to at least one substitutable raw content object to be placed in the template according to the at least one authoring parameter.

14. The method of claim 1, wherein the defining step comprises defining at least one meta-component representing a set of components and transitions.

15. The method of claim 14, wherein the at least one meta-component is a procedurally defined representation of the set of components and transitions.

16. The method of claim 1, wherein each transition represents a permissible movement from one component to another component.

17. The method of claim 1, wherein each transition is associated with a triggering event.

18. The method of claim 17, wherein the triggering event is an event occurring during playback of the audiovisual product.

19. The method of claim 18 wherein the triggering event is receiving a user command, or expiry of a timer.

20. The method of claim 1, further comprising the step of checking expected conformance of the audiovisual product with the predetermined output format, using the plurality of components and the plurality of transitions.

21. The method of claim 20, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

22. The method of claim 20, wherein the checking step comprises predicting an expected total size of the audiovisual product, and comparing the expected total size against a storage capacity of a predetermined storage medium.

23. The method of claim 4, wherein the expanding step comprises, for each component, building one or more of the set of explicitly realised AV assets by reading and manipulating the one or more raw content objects.

24. The method of claim 23, wherein:
the defining step comprises defining at least one choice component comprising a reference to a plurality of raw content objects and at least one authoring parameter; and
the building step comprises:
selecting one or more raw content objects from amongst the plurality of raw content objects using the at least one authoring parameter; and
combining the selected raw content objects to form one of the AV assets.

25. The method of claim 24, comprising repeating the selecting and combining steps to automatically build a plurality of the explicitly realised AV assets from the one of the components.

26. The method of claim 4, wherein the expanding step comprises:
creating from each one of the plurality of components one or more explicitly realised AV assets to provide the set of AV assets;
creating the expanded intermediate data structure wherein each node represents one AV asset of the set; and
creating a set of links between the nodes.

27. The method of claim 26, wherein each transition is associated between first and second components, and creating the set of links comprises evaluating each transition to create one or more links, each of the links being between a node created from the first component and a node created from the second component.

28. The method of claim 4, wherein the expanding step comprises evaluating at least one of the transitions to create exit logic associated with at least one first node, evaluating one of the components to create entry logic associated with at least one second node, and providing a link between the first and second nodes according to the entry logic and the exit logic.

29. The method of claim 28, wherein at least one of the transitions is associated with a triggering event, and the expanding step comprises evaluating the triggering event to determine the exit logic associated with the at least first one node.

30. The method of claim 4, further comprising the step of checking expected conformance of the audiovisual product with the predetermined output format, using the AV assets and the expanded intermediate data structure of nodes and links.

31. The method of claim 30, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

32. The method of claim 31, wherein the checking step comprises predicting an expected total size of the audiovisual product, and comparing the expected total size against a storage capacity of a predetermined storage medium.

33. The method of claim 4, wherein the AV assets have a data format specified according to the predetermined output format.

34. The method of claim 4, wherein the AV assets each have a data format according to the predetermined output format, whilst the raw content objects are not limited to a data format of the predetermined output format.

35. The method of claim, wherein the predetermined output format is a DVD-video specification.

36. The method of any preceding claim 4, wherein the AV assets each comprise a video object, zero or more audio objects, and zero or more sub-picture objects.

37. The method of claim 4, wherein the AV assets each comprise at least one video object, zero to eight audio objects, and zero to thirty-two sub-picture objects, according to the DVD-video specification.

38. The method of claim 4, wherein the creating step comprises creating objects in a hierarchical data structure defined by the predetermined output format with objects at levels of the data structure, according to the intermediate data structure of nodes and links, and where the objects in the hierarchical data structure include objects derived from the explicitly realised AV assets.

39. The method of claim 4, wherein the predetermined output format is a DVD-video specification and the creating step comprises creating DVD-video structure locations from the nodes of the expanded intermediate data structure, placing the explicitly realised AV assets at the created structure locations, and substituting the links of the expanded intermediate data structure with explicit references to the DVD-video structure locations.

40. An authoring method for use in creating a DVD-video product, comprising the steps of:
creating a plurality of components representing parameterised sections of audiovisual content, and a plurality of transitions representing movements between components;
expanding the plurality of components and the plurality of transitions to provide a set of AV assets and an expanded data structure of nodes and links, where each node is associated with an AV asset of the set and the links represent movement from one node to another; and
creating a DVD-video format data structure from the AV assets, using the nodes and links, wherein the DVD-video format data structure comprises data representing merged first and second video data.

41. The method of claim 40, comprising creating at least one information component comprising a reference to an item of AV content.

42. The method of claim 40, comprising creating at least one choice component comprising a reference to at least one item of AV content, and at least one parameter for modifying the item of AV content.

43. The method of claim 42, wherein the choice component comprises a reference to a presentation template and a reference to at least one item of substitutable content to be placed in the template according to the at least one parameter.

44. The method of claim 42, wherein the choice component comprises at least one runtime variable available during playback of an audiovisual product in a DVD player, and at least one authoring parameter not available during playback.

45. The method of claim 40, comprising creating at least one meta-component representing a set of components and transitions.

46. The method of claim 40, wherein each transition represents a permissible movement from one component to another component, each transition being associated with a triggering event.

47. The method of claim 46, wherein a triggering event includes receiving a user command, or expiry of a timer.

48. The method of claim 40, wherein the expanding step comprises:
creating from each one of the plurality of components one or more AV assets to provide the set of AV assets;
creating the expanded data structure wherein each node represents one AV asset of the set; and
creating a set of links between the nodes.

49. The method of claim 42, wherein the expanding step comprises evaluating each choice component to create a plurality of AV assets according to each value of the at least one parameter.

50. The method of claim 49, wherein evaluating each choice component comprises creating entry logic associated with at least one node and/or evaluating at least one transition to create exit logic associated with at least one node, and providing a link between a pair of nodes according to the entry logic and the exit logic.

51. The method of claim 40, comprising the step of checking expected conformance with the DVD-video format using the created components and transitions.

52. The method of claim 40, comprising the step of checking expected conformance with the DVD-video format using the set of AV assets and the expanded data structure of nodes and links.

53. An authoring method for use in creating an audiovisual product according to a DVD-video specification, comprising the steps of:
generating a set of AV assets each comprising a video object, zero or more audio objects and zero or more sub-picture objects, and an expanded data structure of nodes and links, where each node is associated with one AV asset of the set and the links represent navigational movement from one node to another; and
creating a DVD-video format data structure from the set of AV assets, using the nodes and links;
the method characterised by the steps of:
creating a plurality of components and a plurality of transitions, where a component implicitly defines a plurality of AV assets by referring to a presentation template and to items of raw content substitutable in the presentation template, and the plurality of transitions represent navigational movements between components; and
expanding the plurality of components and the plurality of transitions to generate the set of AV assets and the expanded data structure of nodes and links, wherein the set of AV assets and the expanded data structure of nodes and links comprise data representing merged first and second video.

54. A method as claimed in claim 53 for merging first and second data associated with first and second DVD-Video zone directories respectively; the method comprising the steps of: identifying the registers used by at least one of the first and second data; allocating use of the registers to at least one of the first and second data according to said identifying; and creating data associated with video manager information (VMGI) of the DVD-video disc image data to accommodate at least one of the first and second DVD-Video zones.

55. A method as claimed in claim 54 comprising the step of collating the first and second data to produce DVD-Video data.

56. A method as claimed in claim 54, in which at least one of the first and second data comprises at least one of a Group of Pictures, a Video Object, a Video Object Set, a Video Object Unit, a Cell, Program, Part_of_Title, Program Chain, Title, Navigation Pack, Video Pack, Audio Pack or DVD-Video disc image data.

57. A method as claimed in claim 54 in which the step of creating comprises the step of creating menu data of video manager menu data (video_ts.vob) to access at least one of the first and second data.

58. A method as claimed in claim 54, further comprising the step of establishing a backup copy of the data associated with the video manager information.

59. A method as claimed in claim 58 in which the step of establishing a backup copy of the data associated with the video manager information comprises the step of creating VMGI backup information.

60. A method as claimed in claim 54 in which the first and second data were created using respective, different, authoring tools or by different authors using the same tool.

61. A method as claimed in claim 54, further comprising, prior to the step of identifying, the step of determining whether or not at least one of the first and second data has associated copy protection.

62. A method as claimed in claim 54 further comprising the step of creating the first data using a respective authoring tool and performing the steps of any preceding claim using that respective authoring tool.

63. A method as claimed in claim 53 for merging first and second video data (VTSs); the method comprising the steps of:
assessing potential use of a predeterminable resource by at least one of the first and second video data;
allocating use of the predeterminable resource to at least one of the first and second video data according to the step of assessing;
collating the first and second video data to create DVD-Video data; and creating data associated with video manager information (VMGI) of the DVD-Video data to accommodate at least one of the first and second video data.

64. A data processing method as claimed in claim 63, in which the predeterminable resource is at least one of GPRM registers, titles and part titles.

65-66. (canceled).

67. A computer program comprising computer executable instructions for implementing a method or system as claimed in claim 1.

68. A product comprising a storage medium storing a computer program as claimed in claim 67.

69. A storage medium storing an audiovisual product authored according to the method of claim 1.

70. An optical disk having stored thereon an audiovisual product authored according to the method of claim 1.

71 (cancelled).
